(19) United States
(12) Patent Application Publication
(10) Pub. No.: US 2009/0048048 A1
(43) Pub. Date: Feb. 19, 2009

(54) V-RIBBED BELT AND AUTOMOTIVE ACCESSORY DRIVE BELT DRIVE SYSTEM USING THE SAME

(75) Inventors: Takashi Nakamura, Kobe-shi (JP); Hiroyuki Shiriike, Kobe-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: BANDO CHEMICAL INDUSTRIES, LTD., Kobe-shi, Hyogo (JP)

(21) Appl. No.: 11/719,836

(22) PCT Filed: Oct. 24, 2005
(86) PCT No.: PCT/JP05/19477

§ 371 Date: Jul. 7, 2008

(30) Foreign Application Priority Data
Nov. 24, 2004 (JP) 2004-338415

(51) Int. Cl. F16G 5/06

(52) U.S. Cl. 474/263

(57) ABSTRACT

A V-ribbed belt B includes a plurality of V-ribs 13 each formed to extend in a lengthwise direction of the belt, the plurality of V-ribs 13 are disposed in juxtaposition in a widthwise direction of the belt on the belt inner face, and the V-ribbed belt B is wrapped around a pulley to bring the plurality of V-ribs 13 into contact with the pulley for power transmission. The plurality of V-ribs 13 are made of a rubber composition in which 5 to 50 parts by mass of thermoplastic resin having a melting point of 110° C. or higher is mixed with 100 parts by mass of ethylene-α-olefin elastomer rubber which is raw rubber.

### TECHNICAL FIELD

This invention relates to a V-ribbed belt in which a plurality of V-ribs each extending in a lengthwise direction of the belt are disposed in juxtaposition in a widthwise direction of the belt on the inner face of the belt and which is wrapped around a pulley to bring the plurality of V-ribs into contact with the pulley for power transmission and an automotive accessory drive belt drive system using the same.

### BACKGROUND ART

V-ribbed belts are widely used as friction drive belts for driving automotive accessories.

Motor vehicle engines cause an explosive combustion in a regular cycle. This has a minor effect on the angular velocity of an associated crank shaft and, therefore, causes a fluctuation in the engine revolution speed. When such a revolution fluctuation occurs, a V-ribbed belt wrapped around an associated crankshaft pulley cannot follow the revolution fluctuation and causes a stick slip on the pulley. When the V-ribbed belt causes a stick slip on the pulley, stick-slip noise is produced as an abnormal noise. Therefore, in order to prevent the production of such stick-slip noise, V ribbed belts are generally configured so that short fibers are mixed into a compression rubber layer forming the belt inner peripheral side so as to be oriented along the belt widthwise direction and the short fibers protrude from the belt surfaces to reduce the coefficient of friction on the belt surfaces. Furthermore, various other techniques are also proposed for reducing noises during travel of a V-ribbed belt.

For example, Patent Document 1 discloses a V-ribbed belt whose compression rubber layer is provided with opposed friction drive faces and in which easy-to-fibrillate aramid short fibers and hard-to-fibrillate aramid short fibers are mainly embedded in a distal constituent part of the compression rubber layer towards the distal end thereof and a basal constituent part which is the remaining part of the compression rubber layer, respectively, while keeping their orientation in the belt widthwise direction. The document describes that, in the power transmission belt having V-shaped compression rubber layer parts, since aramid short fibers mixed in the compression rubber layer for the purpose of provision of wear resistance and lateral pressure resistance are given a change in material partway through the compression rubber layer, this prevents the production of rubbing sounds during travel of a belt of such kind wrapped around a pulley while ensuring the wear resistance and lateral pressure resistance of the compression rubber layer.

Patent Document 2 discloses a V-ribbed belt which comprises an adhesion rubber layer having a cord embedded therein along the belt lengthwise direction and a compression rubber layer having a plurality of ribs extending along the belt lengthwise direction and in which a distal part of each rib is made of a rubber composition obtained by adding, to hydrogenated acrylonitrile-butadiene rubber in which 80% or more of double bonds in acrylonitrile-butadiene rubber are hydrogenated, microfibril-reinforced rubber in which rubber of the same material as or similar material to the above hydrogenated acrylonitrile-butadiene rubber and polyamide fibers of 1.0 μm or smaller fiber diameter are graft polymerized, and the remaining part of each rib is formed of a rubber composition obtained by containing short fibers having a larger diameter than polyamide fibers into hydrogenated acrylonitrile-butadiene rubber. The document describes that since the V-ribbed belt is excellent in crack resistance, heat resistance, lateral pressure resistance and flexibility, this significantly elongates the belt life and reduces noise.

Patent Document 3 discloses a V-ribbed belt which comprises a tension member layer formed so that a tension member is embedded in an adhesion rubber layer and a compression rubber layer underlying the tension member layer and having a plurality of V-ribs arranged in parallel to extend in the belt lengthwise direction, and in which the compression rubber layer is formed of a rubber compound in which 0.75 to 1.50 parts by weight of wax having a melting point of 40 to 80° C. is blended into 100 parts by weight of rubber mainly composed of chloroprene polymer. The document describes that, according to the V-ribbed belt, since the rubber compound of the compression rubber layer forming the V-ribs is improved, this prevents the production of noise due to sticking resulting from excessive tension in an early stage of belt travel and belt slip sounds upon abrupt load application with the tension reduced with the passage of the belt travel time.

The above-mentioned prior art V-ribbed belts can be expected to bring about the effect of preventing the production of abnormal noise if they are brand-new and in their initial stages of use. However, after vehicles have run 20000 to 40000 km, the V-ribbed belts cannot maintain the effect and invite a problem that stick-slip noise is produced.

For example, in the technique disclosed in Patent Document 1, the surfaces of V-ribs of a brand-new V-ribbed belt, serving as contact surfaces with a pulley, are covered with a large number of short fibers. Therefore, the short fibers act like a roller to give the surfaces of the V-ribs a low coefficient of friction, which prevents the occurrence of stick slips. However, after the vehicle has run for a long period, the short fibers on the V-rib surfaces wear owing to friction on the pulley. Thus, as the proportion of rubber exposure on the V-rib surfaces increases, the coefficient of friction of the V-rib surfaces also increases, thereby producing stick-slip noise.

In the technique disclosed in Patent Document 2, the microfibril-reinforced rubber surely provides excellent rubber crack resistance and flexibility. Also in this case, however, after the vehicle has run for a long period, the coefficient of friction of the V-rib surfaces increases as the proportion of rubber exposure on the V-rib surfaces increases. As a result, stick-slip noise is produced.

In the technique disclosed in Patent Document 3, the V-ribbed belt uses a rubber composition in which wax having a melting point of 40 to 80° C. is mixed. Therefore, the surfaces of V-ribs of a brand-new V-ribbed belt, serving as contact surfaces with a pulley, have a low coefficient of friction because of a lubrication effect of the rubber composition, thereby preventing the occurrence of stick slips. However, after the vehicle has run for a long period, the belt may have a history that the belt temperature is heated up to 80 to 110° C. In such a case, the wax might be melted away and almost lost from the V-rib surfaces and the coefficient of friction of the V-rib surfaces might increase, thereby producing stick-slip noise.

Particularly when the driving load of an accessory is large, such as when a headlight or an air-conditioner is turned on, and when the revolution fluctuation is large, such as when the engine is accelerated at wide open throttle (WOT) in the D range, stick-slip noise after a long-term run of the vehicle as described above are more likely to occur because the variation in tension to the V-ribbed belt becomes large.

Furthermore, stick-slip noise involved in revolution fluctuation is characterized in that it is more likely to occur as the tension applied to the V-ribbed belt is lower. When the tension applied to the V-ribbed belt is low and the driving load of the accessory is large, the V-ribbed belt cannot transmit power and causes a sliding slip. A region in which the V-ribbed belt transfers from elastic slip, which shows the belt is in a normal power transmission region, to sliding slip is an uncertain region in which the V-ribbed belt either grips the pulley to transmit power or cannot grip the pulley and slips thereon. Therefore, when a load variation occurs in the uncertain region, the V-ribbed belt accordingly slips on the pulley at high loads or grips the pulley at low loads, thereby alternating slips and grips in cycles of revolution fluctuation. Thus, a squeaky noise is intermittently repeated at moments of slips to produce uncomfortable intermittent sounds of “squeak-squeak”, namely, stick-slip noise. Particularly if the manner of assembling the belt onto a pulley is a tension-fixed manner in which a pulley is fixed by applying a specified tension to the V-ribbed belt, the tension is gradually reduced with time because of a long-term run of the vehicle and, therefore, stick-slip noise as described above is likely to occur.

To cope with this, the inventors developed, as a V-ribbed belt specified to produce no stick-slip noise even after a long-term run of the vehicle, one formed of a rubber composition in which 25 parts by mass of nylon short fibers of 28 μm fiber diameter are mixed with ethylene-propylene-diene monomer rubber (EPDM) which is raw rubber, and the V-ribbed belt was produced in large quantities. At that time, since the V-ribbed belt specified as above contains small-coefficient-of-friction, large-diameter nylon short fibers as much as 25 parts by mass in 100 parts by mass of raw rubber, the V-ribbed belt could keep a small coefficient of friction even after a long-term run of the vehicle because of a large proportion of exposure of short fibers on the V-rib surfaces serving as contact faces with a pulley and could thereby prevent the production of stick-slip noise. In fact, inconveniences due to stick-slip noise in the market drastically reduced. In view of reduction of stick-slip noise, it was considered that mixture of larger quantity of nylon short fibers of larger fiber diameter into raw rubber was preferable. Since, however, this provides deteriorated flexural fatigue resistance, 25 parts by mass of nylon short fibers of 28 μm fiber diameter was the limit of mixture into 100 parts by mass of raw rubber.

The inventors believed that the above technique solved the problem of production of stick-slip noise. In recent years, however, the problem has taken on a new dimension.

Specifically, the need to improve vehicle fuel economy has promoted direct injection technology and lean burn technology of engines. These technologies both involved significant increase in fluctuation of the engine revolution speed and, therefore, increased the variation in tension applied to V-ribbed belts that is a cause to produce stick-slip noise.

In addition, a new fact has been also found that the tension applied to V-ribbed belts has a significant effect on vehicle fuel economy. Specifically, when the tension applied to a V-ribbed belt increases, the axial load placed on its accessories and crank shaft becomes higher, which increases the friction loss and in turn deteriorates the fuel economy. This means that if the tension applied to the V-ribbed belt is lowered, the fuel economy can be improved. Conventionally, the tension applied to a V-ribbed belt is set at 150 to 200 N per V-rib in assembling it onto pulleys so that its stable tension after a long-term run of the vehicle reaches 80 to 120 N (100 N on average) per V-rib. However, it has been found that, in order to significantly improve the fuel economy, the initial tension in assembly should be set at 80 to 120 N per V-rib so that the stable tension could reach an average of 60 N (40 to 80 N on average) per V-rib. As described above, low tensions applied to a V-ribbed belt provide ease of production of stick-slip noise. The stable tension averaging 60 N per V-rib is very close to the region in which V-ribbed belts slidingly slip.

In this manner, there is a new demand for V-ribbed belts to produce no stick-slip noise after a long-term vehicle run even if they are used for engines having very large revolution fluctuations and the tension applied thereto is low. By way of experiment, a V-ribbed belt was made of a rubber composition in which 25 parts by mass of nylon short fibers of 28 μm fiber diameter were mixed with 100 parts by mass of EPDM which is raw rubber. When the V-ribbed belt was moved by motoring for 100 hours (which was expected to correspond to a vehicle run for 20000 km), then assembled to an accessory drive belt drive system for an engine having a large revolution fluctuation with a tension of 60 N per V-rib applied and then moved, stick-slip noise was recognized.

The present invention has been made in view of the foregoing and, therefore, its object is to provide a V-ribbed belt which prevents the production of stick-slip noise after a long-term vehicle run even if it is used in an automotive accessory drive belt drive system having a large engine revolution fluctuation and the tension applied to it is low and to provide an automotive accessory drive belt drive system which is equipped with the V-ribbed belt.
Patent Document 1: Published Japanese Utility-Model Application No. H05-59012
Patent Document 2: Published Japanese Patent Application No. H07-35201
Patent Document 3: Published Japanese Patent Application No. H07-293641

### DISCLOSURE OF THE INVENTION

The present invention for attaining the above object is directed to a V-ribbed belt including a plurality of V-ribs each formed to extend in a lengthwise direction of the belt, the plurality of V-ribs being disposed in juxtaposition in a widthwise direction of the belt on the inner face of the belt, the V-ribbed belt being wrapped around a pulley to bring the plurality of V-ribs into contact with the pulley for power transmission, wherein

the plurality of V-ribs are made of a rubber composition in which 5 to 50 parts by mass of thermoplastic resin having a melting point of 110° C. or higher is mixed with 100 parts by mass of ethylene-α-olefin elastomer rubber which is raw rubber.

If the V-ribs of a V-ribbed belt are made of a rubber composition containing chloroprene rubber (CR) as raw rubber, the surfaces of the V-ribs serving as contact surfaces with a pulley are hardened and deteriorated into mirror surfaces by heat production due to friction and their coefficient of friction extremely increases. Therefore, upon change of tension due to fluctuation in the engine revolution speed in use of such a V-ribbed belt in an automotive accessory drive belt drive system, the belt grips the pulley to a limit and then slips on the pulley at once, which leads to ease of production of stick-slip noise. In contrast, according to the above configuration of the V-ribbed belt of the present invention, since the V-ribs are made of a rubber composition containing ethylene-α-olefin elastomer rubber as raw rubber, they have a high heat resistance. Therefore, the surfaces of the V-ribs can be prevented from being hardened and deteriorated into mirror surfaces by heat production due to friction, which makes it hard to produce stick-slip noise. The term “ethylene-α-olefin elastomer rubber” as used herein covers, for example, ethylene-propylene copolymer rubber (EPM), ethylene-propylene-diene monomer terpolymer rubber (EPDM) and their mixtures.

Since thermoplastic resin is mixed into the rubber composition forming the V-ribs, the thermoplastic resin exposed at the surfaces of the V-ribs serving as contact surfaces with the pulley keeps the coefficient of friction low even if the V-ribs wear down. In addition, in transferring the V-ribbed belt from a state of gripping the pulley to a state of slipping on the pulley at a critical point of transition from an elastic slip region to a sliding slip region, the thermoplastic resin appropriately elastically deforms to provide a smooth state transfer. Therefore, stick-slip noise is less likely to occur. Furthermore, since the thermoplastic resin has a melting point of 110° C. or higher, even if the belt temperature reaches 80 to 100° C. as when the V-ribbed belt is used in an automotive accessory drive belt drive system, the thermoplastic resin never melts away and its effects can be kept for a long time.

Therefore, according to the above configuration of the V-ribbed belt of the present invention, even if the V-ribbed belt is used in an automotive accessory drive belt drive system having a large engine revolution fluctuation and the tension applied to it is low, production of stick-slip noise after a long-term vehicle run can be prevented.

The reason why the amount of thermoplastic resin mixed with raw rubber is 5 to 50 parts by mass both inclusive is as follows. If the amount of thermoplastic resin is smaller than 5 parts by mass, the above effects of the thermoplastic resin cannot sufficiently be obtained. On the other hand, if the amount of thermoplastic resin is larger than 50 parts by mass, a large number of defects whose cores are formed by the thermoplastic resin are contained in the entire belt, which deteriorates the flexural fatigue resistance.

Examples of thermoplastic resin having a melting point of 110° C. or higher include polyethylene resin having a melting point of 110 to 140° C., polypropylene resin having a melting point of 176° C., 6,6-nylon resin having a melting point of 265° C., polyethylene terephthalate resin having a melting point of 264° C. and ethylene tetrafluoride resin having a melting point of 327° C.

In the V-ribbed belt according to the present invention, the thermoplastic resin may have a thermal deformation temperature of 80° C. or lower.

With the above configuration, since the thermoplastic resin has a thermal deformation temperature of 80° C. or lower, which is equal to or lower than the belt temperature (80 to 100° C.) during use in an automotive accessory drive belt drive system, the thermoplastic resin softened smoothly elastically deforms when the V-ribbed belt makes a transition from a state of gripping the pulley to a state of slipping on the pulley.

The thermal deformation temperature as employed herein is a measured value under a load of 18.6 kg/cm specified in ASTM D-648.

Examples of thermoplastic resin having a thermal deformation temperature of 80° C. or lower include polyethylene resin having a thermal deformation temperature of 32 to 52° C., polypropylene resin having a thermal deformation temperature of 60 to 70° C. and 6,6-nylon resin having a thermal deformation temperature of 60 to 65° C.

In the V-ribbed belt according to the present invention, the most preferable thermoplastic resin is polyethylene resin.

With the above configuration, since the polyethylene resin has a low coefficient of friction and a thermal deformation temperature of 32 to 52° C., it more elastically deforms at belt temperatures of 80 to 100° C. than the other kinds of resins when used in an automotive accessory drive belt drive system, thereby providing a smoother transfer from a state of gripping to a state of slipping. Furthermore, since the polyethylene resin has a high affinity to ethylene-α-olefin elastomer rubber containing a polyethylene component, it exhibits a good dispersed state in the rubber composition.

In the V-ribbed belt according to the present invention, the polyethylene resin serving as the thermoplastic resin is more preferably ultrahigh molecular weight polyethylene resin having a viscosity-average molecular weight of 500000 or more.

With the above configuration, ultrahigh molecular weight polyethylene resin having a viscosity-average molecular weight of 500000 or more has not only a low coefficient of friction but also a very good wear resistance. Therefore, when the V-ribbed belt is used in an automotive accessory drive belt drive system and even after the vehicle has run for a long period of time, the ultrahigh molecular weight polyethylene resin can be held on the surfaces of the V-ribs serving as contact surfaces with the pulley. The viscosity-average molecular weight is determined by the viscosity method.

In the V-ribbed belt according to the present invention, the thermoplastic resin may be in powder or particulate form.

With the above configuration, since the thermoplastic resin is in powder or particulate form, this prevents inhabitation of extensional deformation of the rubber composition forming the V-ribs and thereby prevents an adverse effect on the flexural fatigue resistance.

In this case, in the V-ribbed belt according to the present invention, the thermoplastic resin in powder or particulate form preferably has a particle diameter of 25 to 300 μm.

If the particle diameter of the thermoplastic resin is smaller than 20 μm, the surfaces of the V-ribs serving as contact surfaces with the pulley are more likely to be covered with wear powder with time, which dilutes the effects of the thermoplastic resin. On the other hand, if the particle diameter of the thermoplastic resin is larger than 300 μm, the rubber composition forming the V-ribs cannot uniformly deform and stress concentrates on and around the thermoplastic resin, which provides a poor flexural fatigue resistance.

In the V-ribbed belt according to the present invention, 3 to 30 parts by mass of short fibers may be mixed into the rubber composition forming the plurality of V-ribs with respect to 100 parts by mass of ethylene-α-olefin elastomer rubber which is raw rubber, the short fibers being oriented in the widthwise direction of the belt.

Although the effect of preventing the production of stick-slip noise can be exhibited simply by mixing thermoplastic resin into the rubber composition forming the V-ribs, the effect can be exhibited to a greater extent in combination with mixture of short fibers. The entrance and exit of the V-ribs into and from the pulley grooves is a source of stick-slip noise. Specifically, if, in the engagement of the V-ribs into the pulley grooves, the V-ribs are deformed by lateral pressure, wedge into the pulley grooves and thereby exhibit a high wedge effect, then they produce stick-slip noise when disengaged away from the pulley grooves. Therefore, in view of prevention of production of stick-slip noise, it is preferable that the V-ribs are not deformed by lateral pressure as much as possible. Then, in order to prevent the V-ribs from being deformed by lateral pressure, it can be considered to add carbon black or a resinous reinforcing agent to the rubber composition. This, however, hardens the V-ribs to make their flexural fatigue resistance poor. In contrast, according to the above configuration of the V-ribbed belt of the present invention, short fibers are mixed into the V-ribs so as to be oriented in the belt widthwise direction. Therefore, while the V-ribs exhibit a high stiffness against lateral pressure, their lengthwise flexibility is hardly impaired and, therefore, the V-ribs do not have an excessive wedge effect on the pulley grooves. As a result, the V-ribbed belt becomes less likely to produce stick-slip noise.

If the amount of short fibers mixed is smaller than 3 parts by mass with respect to 100 parts by mass of raw rubber, the stiffness of the V-ribs in the belt widthwise direction cannot sufficiently be enhanced. On the other hand, if the amount of short fibers mixed is larger than 30 parts by mass, the short fibers cannot uniformly be dispersed into the rubber composition, which provides a poor flexural fatigue resistance.

Examples of short fibers include nylon short fibers, meta-aramid short fibers, para-aramid short fibers and cotton short fibers.

In this case, in the V-ribbed belt according to the present invention, the most preferable short fibers are nylon short fibers.

The reason for the above is that not only nylon short fibers increase the stiffness of the V-ribs in the belt widthwise direction but also, because of low coefficient of friction of their own, they are left on the surfaces of the V-ribs serving as contact surfaces with the pulley even after wearing down, thereby providing an effect of reducing the coefficient of friction of the surfaces of the V-ribs.

The V-ribbed belt according to the present invention may further comprise a cord made of polyethylene naphthalate fibers and embedded to form a spiral with a certain pitch in the widthwise direction of the belt.

With the above configuration, since the cord is used in combination with the V-ribs made of a rubber composition in which thermoplastic resin is mixed with ethylene-α-olefin elastomer rubber, this provides an extremely large effect of preventing the production of stick-slip noise. Specifically, for example, where the V-ribbed belt is assembled to an automotive accessory drive belt drive system of large revolution fluctuation with a low tension applied thereto, it provides power transmission in a condition close to a critical point of transition from an elastic slip region to a sliding slip region. In this case, because the cord made of polyethylene naphthalate fibers gives the V-ribbed belt a higher modulus of elasticity than that made of polyethylene terephthalate, the V-ribbed belt does not simply transfer from an elastic slip region to a sliding slip region even upon change of the tension. This results in preventing the production of stick-slip noise.

An automotive accessory drive belt drive system according to the present invention includes: a V-ribbed belt in which a plurality of V-ribs each formed to extend in a lengthwise direction of the belt are disposed in juxtaposition in a widthwise direction of the belt on the inner face of the belt; and a plurality of pulleys around which the V-ribbed belt is wrapped in a tension-fixed manner, wherein

the plurality of V-ribs of the V-ribbed belt are made of a rubber composition in which 5 to 50 parts by mass of thermoplastic resin having a melting point of 110° C. or higher is mixed with 100 parts by mass of ethylene-α-olefin elastomer rubber which is raw rubber, and

the tension applied to the V-ribbed belt before running is 50 to 80 N per V-rib.

With the above configuration, the automotive accessory drive belt drive system is prevented from producing stick-slip noise even after a long-term run of the vehicle. Furthermore, since the tension applied to the V-ribbed belt is low, the axial load placed on each pulley is low, resulting in low fuel consumption of the engine.

### BRIEF DESCRIPTION OF DRAWINGS

FIG. 1 is a perspective view of a V-ribbed belt according to an embodiment of the present invention.

FIG. 2 is a diagram showing the pulley layout of an accessory drive belt drive system.

FIG. 3 is a diagram showing the pulley layout of a deterioration accelerating belt running tester.

FIG. 4 is a diagram showing the pulley layout of a belt running tester for a multi-axis bending test.

FIG. 5 is a bar graph showing sound characteristics of V-ribbed belts of Examples 1 to 8.

FIG. 6 is a bar graph showing bending fatigue lives of V-ribbed belts of Examples 1 to 8.

### BEST MODE FOR CARRYING OUT THE INVENTION

A detailed description is given below of an embodiment of the present invention with reference to the drawings.

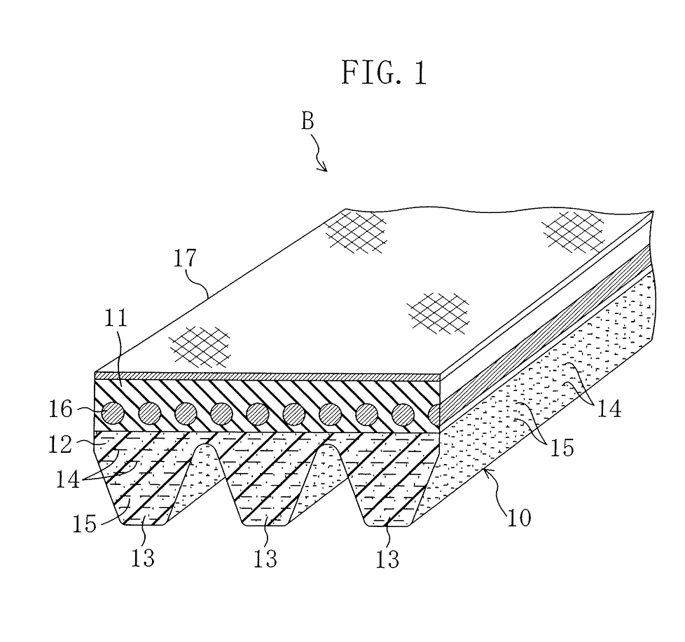

FIG. 1 shows a V-ribbed belt B according to an embodiment of the present invention.

The V-ribbed belt B includes a V-ribbed belt body 10, a cord 16 embedded in the V-ribbed belt body 10 to form a spiral with a certain pitch in the belt widthwise direction, and a back face reinforcement fabric 17 provided to cover the back face of the V-ribbed belt body 10.

The V-ribbed belt body 10 is made of a rubber composition obtained by using ethylene-α-olefin elastomer rubber as raw rubber, mixing rubber compounding chemicals including a filler, such as carbon black, and a plasticizer into the rubber and applying heat and pressure to the rubber mixture to crosslink the raw rubber component of the rubber mixture with an organic peroxide or sulfur. Examples of the above ethylene-α-olefin elastomer rubber include ethylene-propylene copolymer rubber (EPM), ethylene-propylene-diene monomer terpolymer rubber (EPDM) and their mixtures. The V-ribbed belt body 10 has a structure in which an adhesion rubber layer 11 having the cord 16 embedded therein and a compression rubber layer 12 underlying the adhesion rubber layer 11 are stacked and integrated with each other.

The adhesion rubber layer 11 is a part including the cord 16 embedded therein to resist a tension and is formed in the shape of a strip.

The compression rubber layer 12 is a part that is brought into contact with a pulley placed inwardly of the belt to directly transmit power to the pulley and in which V-ribs 13 extending in the belt lengthwise direction are formed in juxtaposition in the belt widthwise direction to provide a large contact area with the pulley.

The rubber composition containing as raw rubber ethylene-α-olefin elastomer rubber and forming the compression rubber layer 12 contains, in addition to rubber compounding chemicals such as carbon black, a thermoplastic resin 15 of 110° C. or lower melting point and 80° C. or lower thermal deformation temperature (under a load of 18.6 kg/cm specified in ASTM D-648) dispersedly mixed thereinto. The thermoplastic resin 15 is mixed at 5 to 50 parts by mass with 100 parts by mass of raw rubber. The thermoplastic resin 15 is ultrahigh molecular weight polyethylene resin having a viscosity-average molecular weight of 500000 or more. Furthermore, the thermoplastic resin 15 is in powder or particulate form of a particle diameter of 25 to 300 μm.

The rubber composition forming the compression rubber layer 12 also contains short fibers 14 dispersedly mixed thereinto so as to be oriented in the belt widthwise direction. The short fibers 14 are mixed at 3 to 30 parts by mass with 100 parts by mass of raw rubber. The short fibers 14 are nylon short fibers. The short fibers 14 exposed at the surfaces of the V-ribs 13 protrude from the surfaces of the V-ribs 13. Furthermore, the short fibers 14 have a fiber length of 0.2 to 3.0 mm.

The cord 16 is composed of twisted strands of polyethylene naphthalate fibers (hereinafter referred to as “PEN”). In order to give the cord 16 an adhesiveness to the V-ribbed belt body 10, the cord 16 is subjected, prior to molding, to a stretch thermofixation treatment of dipping it in an aqueous solution of resorcinol formaldehyde latex (hereinafter referred to as an “RFL aqueous solution”) and then stretching it while applying heat to it and a treatment of dipping the cord 16 in rubber cement and then drying it. The twisted PEN fiber strands forming the cord 16 have a monofilament diameter of 10 to 40 μm and a total denier of 4000 to 8000 dtex and, for example, have a ply twist of 1100 dtex/2×3 at a twist multiplier of 700 (wherein the twist multiplier is a product of the square root of the denier value and the twist number in turns/10 cm). Furthermore, the twisted PEN fiber strands have a dry heat shrinkage stress of 0.2 to 0.5 cN/dtex prior to the stretch thermofixation treatment and the rubber cement dip treatment and a dry heat shrinkage stress of 0.3 to 0.7 cN/dtex after the stretch thermofixation treatment and the rubber cement dip treatment, where both the shrinkage stress measurements were made according to “Testing Method for Chemical Fiber Tire Cords” of JIS L1017.

The back face reinforcement fabric 17 is composed of a woven fabric made of warp and weft yarns as by plain weaving. In order to give the back face reinforcement fabric 17 an adhesiveness to the V-ribbed belt body 10, the back face reinforcement fabric 17 is subjected, prior to molding, to a treatment of dipping it in an RFL aqueous solution and then heating it and a treatment of coating rubber cement on its surface facing the V-ribbed belt body 10 and then drying it.

In the V-ribbed belt B having the above configuration, since the V-ribs 13 are made of a rubber composition containing ethylene-α-olefin elastomer rubber as raw rubber, they have a high heat resistance. Therefore, the surfaces of the V-ribs 13 are prevented from being hardened and deteriorated into mirror surfaces by friction-induced heat production. This makes it hard to produce stick-slip noise.

In the V-ribbed belt B, the thermoplastic resin 15 is mixed into the rubber composition forming the V-ribs 13. Therefore, even if the V-ribs 13 wear down, the thermoplastic resin 15 exposed at the surfaces of the V-ribs 13, which are contact surfaces with the pulley, holds their coefficient of friction low. In addition, in transferring the V-ribbed belt B from a state of gripping the pulley to a state of slipping on the pulley at a critical point of transition from an elastic slip region to a sliding slip region, the thermoplastic resin 15 appropriately elastically deforms to provide a smooth state transfer. As a result, production of stick-slip noise can be prevented. Furthermore, since the thermoplastic resin 15 is polyethylene resin having a low coefficient of friction and a thermal deformation temperature of 32 to 52° C., it is more likely to elastically deform at belt temperatures of 80 to 100° C. than the other kinds of resins when used in an automotive accessory drive belt drive system, thereby providing a smoother transfer from a state of gripping to a state of slipping. Furthermore, since the thermoplastic resin 15 is ultrahigh molecular weight polyethylene resin having a viscosity-average molecular weight of 500000 or more, it has not only a low coefficient of friction but also a very good wear resistance. Therefore, when the V-ribbed belt B employing the thermoplastic resin 15 is used in an automotive accessory drive belt drive system and even after the vehicle has run for a long period of time, the ultrahigh molecular weight polyethylene resin is held on the surface of the V-ribs 13 serving as contact surfaces with the pulley. In addition, the ultrahigh molecular weight polyethylene resin forming the thermoplastic resin 15 is in powder or particulate form, this prevents inhabitation of extensional deformation of the rubber composition forming the V-ribs 13 and thereby prevents an adverse effect on the flexural fatigue resistance. Furthermore, since the polyethylene resin has a high affinity to ethylene-α-olefin elastomer rubber containing a polyethylene component, it exhibits a good dispersed state in the rubber composition.

In the V-ribbed belt B, the thermoplastic resin 15 has a melting point of 110° C. or higher. Therefore, even if the belt temperature reaches 80 to 100° C. as when the V-ribbed belt B is used in an automotive accessory drive belt drive system, the thermoplastic resin 15 never melts away and the above effects can be kept for a long time.

In the V-ribbed belt B, short fibers 14 are mixed into the compression rubber layer 12 so as to be oriented in the belt widthwise direction. Therefore, while the V-ribs 13 exhibit a high stiffiness against lateral pressure, their lengthwise flexibility is hardly impaired and, therefore, the V-ribs 13 do not have an excessive wedge effect on the pulley grooves. This makes it difficult to produce stick-slip noise. In addition, since the short fibers 14 are nylon short fibers, not only this enhances the stiffness of the V-ribs 13 in the belt widthwise direction but also, because of low coefficient of friction of their own, they are left on the surfaces of the V-ribs 13 serving as contact surfaces with the pulley even after wearing down, thereby providing an effect of reducing the coefficient of friction of the surfaces of the V-ribs 13.

In the V-ribbed belt B, the use of a cord 16 made of PEN is combined with the compression rubber layer 12 being made of a rubber composition in which thermoplastic resin 15 is mixed with ethylene-α-olefin elastomer rubber. This provides an extremely large effect of preventing the production of stick-slip noise. Specifically, where the V-ribbed belt B is assembled to an automotive accessory drive belt drive system of small revolution fluctuation with a low tension applied thereto, it provides power transmission in a condition close to a critical point of transition from an elastic slip region to a sliding slip region. In this case, because the cord 16 made of PEN gives the V-ribbed belt B a higher modulus of elasticity than that made of polyethylene terephthalate (PET), the V-ribbed belt B does not simply transfer from an elastic slip region to a sliding slip region even upon change of the tension. This results in preventing the production of stick-slip noise.

Although the above configuration uses polyethylene resin as a thermoplastic resin 15, the thermoplastic resin 15 is not limited to this but may be nylon resin having excellent wear resistance, polyester resin, polypropylene resin, acrylonitrile butadiene styrene resin (ABS resin) or other thermoplastic resins. Furthermore, although in the above configuration nylon short fibers are used as short fibers 14, the short fibers 14 are not limited to nylon short fibers but may be high-strength para-aramid short fibers, meta-aramid short fibers having excellent wear resistance, cotton short fibers or other kinds of short fibers.

Next, a brief description is given of a fabrication method of a V-ribbed belt B having the above configuration.

In fabricating a V-ribbed belt B, an inner mold having a molding surface for forming the belt back face into a predetermined shape and a rubber sleeve having a molding surface for forming the belt inner face into a predetermined shape are used for the outer and inner peripheries, respectively, of the V-ribbed belt B.

The outer periphery of the inner mold is first covered with a back face reinforcement fabric 17 made of a woven fabric subjected to a treatment for applying an adhesive thereto, and an uncrosslinked rubber sheet for forming a back face side part of the adhesion rubber layer 11 is then wrapped around the back face reinforcement fabric 17.

Subsequently, a cord 16 formed of twisted strands of PEN and subjected to a treatment for applying an adhesive thereto is wound in a spiral form around the uncrosslinked rubber sheet, another uncrosslinked rubber sheet for forming an inner face side part of the adhesion rubber layer 11 is then wrapped around the cord-wound uncrosslinked rubber sheet, and still another uncrosslinked rubber sheet for forming a compression rubber layer 12 is then wrapped around the second uncrosslinked rubber sheet. In this case, a material used as the uncrosslinked rubber sheet for forming the compression rubber layer 12 is a rubber composition in which rubber compounding chemicals including a filler, such as carbon black, and a plasticizer, a thermoplastic resin 15 and short fibers 14 oriented in the wrapping direction are mixed with ethylene-α-olefin elastomer rubber which is raw rubber. In wrapping each uncrosslinked rubber sheet, both ends thereof in the wrapping direction are not overlapped with each other but butted to each other.

Thereafter, the rubber sleeve is fitted onto the molding article on the inner mold and they are placed into a molding pan. Then, the inner mold is heated as by hot steam and a high pressure is applied to the rubber sleeve to press it radially inwardly. During the time, the rubber component fluidizes, a crosslinking reaction proceeds and adhesion reactions of the cord 16 and the back face reinforcement fabric 17 to the rubber also proceed. Thus, a cylindrical belt slab is molded.

Then, the belt slab is removed from the inner mold and separated at different locations of the length into several pieces, and the outer periphery of each separated piece is ground to form V-ribs 13.

Finally, the separated belt slab piece having V-ribs 13 formed on the outer periphery is sliced in round pieces of predetermined width and each round piece is turned inside out to provide a V-ribbed belt B.

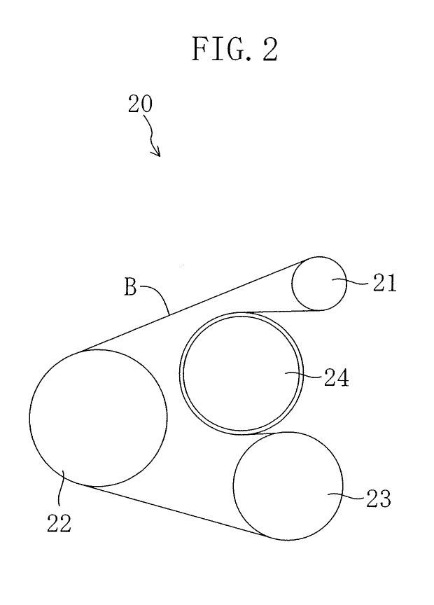

FIG. 2 shows the layout of a fixed-layout accessory drive belt drive system 20 using a V-ribbed belt B in a motor vehicle engine.

The layout of the accessory drive belt drive system 20 includes an uppermost alternator pulley 21, a crankshaft pulley 22 disposed downwardly leftward of the alternator pulley 21, an air-conditioner pulley 23 disposed to the right of the crankshaft pulley 22 and a water pump pulley 24 disposed upwardly leftward of the air-conditioner pulley 23 and downwardly leftward of the alternator pulley 21. Out of these pulleys, all the pulleys other than the water pump pulley 23, which is a flat pulley, are V-ribbed pulleys. The V-ribbed belt B is arranged so as to be wrapped around the alternator pulley 21 to allow its V-ribs 13 to come into contact with the alternator pulley 21, then sequentially wrapped around the crankshaft pulley 22 and the air-conditioner pulley 23 to allow its V-ribs 13 to come into contact with these pulleys, then wrapped around the water pump pulley 24 to allow its back face to come into contact with the water pump pulley 24, and then returned to the alternator pulley 21. The tension applied to the V-ribbed belt B before running gradually reduces with time from its assembly (for example, until after 20000 to 40000 km run of a motor vehicle) and then keeps a constant value. Assuming that the constant value is a stable tension, the stable tension for the accessory drive belt drive system is 50 to 80 N per V-rib.

The above accessory drive belt drive system produces no stick-slip noise even after a long-term run of the vehicle. Furthermore, since the tension applied to the V-ribbed belt is low, the axial load placed on each pulley is low, resulting in low fuel consumption of the engine.

### EXAMPLES

A description is given of test evaluations made on V-ribbed belts.

(Belts for Test Evaluation)

The following V-ribbed belts of Examples 1 to 8 were fabricated.

### Example 1

A V-ribbed belt was fabricated as Example 1 with the same configuration as the above embodiment in which EPDM was used as raw rubber providing a rubber component and the compression rubber layer was formed from a rubber composition obtained by blending 50 parts by mass of carbon black, 14 parts by mass of paraffinic oil as a softener, 5 parts by mass of zinc oxide, 1 part by mass of stearic acid, 3 parts by mass of antioxidant, 1.5 parts by mass of sulfur as a vulcanizing agent, 4 parts by mass of vulcanization accelerator and 20 parts by mass of nylon short fibers with 100 parts by mass of EPDM.

### Example 2

A V-ribbed belt was fabricated as Example 2 with the same configuration as Example 1 except that the compression rubber layer was formed from a rubber composition in which 2 parts by mass of polyethylene resin powder is blended with 100 parts by mass of EPDM.

### Example 3

A V-ribbed belt was fabricated as Example 3 with the same configuration as Example 1 except that the compression rubber layer was formed from a rubber composition in which 5 parts by mass of polyethylene resin powder is blended with 100 parts by mass of EPDM.

### Example 4

A V-ribbed belt was fabricated as Example 4 with the same configuration as Example 1 except that the compression rubber layer was formed from a rubber composition in which 10 parts by mass of polyethylene resin powder is blended with 100 parts by mass of EPDM.

### Example 5

A V-ribbed belt was fabricated as Example 5 with the same configuration as Example 1 except that the compression rubber layer was formed from a rubber composition in which 20 parts by mass of polyethylene resin powder is blended with 100 parts by mass of EPDM.

### Example 6

A V-ribbed belt was fabricated as Example 6 with the same configuration as Example 1 except that the compression rubber layer was formed from a rubber composition in which 40 parts by mass of polyethylene resin powder is blended with 100 parts by mass of EPDM.

### Example 7

A V-ribbed belt was fabricated as Example 7 with the same configuration as Example 1 except that the compression rubber layer was formed from a rubber composition in which 60 parts by mass of polyethylene resin powder is blended with 100 parts by mass of EPDM.

### Example 8

A V-ribbed belt was fabricated as Example 8 with the same configuration as Example 1 except that chloroprene rubber was used as raw rubber providing a rubber component and the compression rubber layer was formed from a rubber composition obtained by blending 50 parts by mass of carbon black, 5 parts by mass of plasticizer, 5 parts by mass of zinc oxide, 1 part by mass of stearic acid, 3 parts by mass of antioxidant, 4 parts by mass of magnesium oxide and 20 parts by mass of nylon short fibers with 100 parts by mass of chloroprene rubber.

The formulae of the rubber compositions of Examples 1 to 8 are also shown in Table 1.

(Test Evaluation Method)

<Real Machine Test>

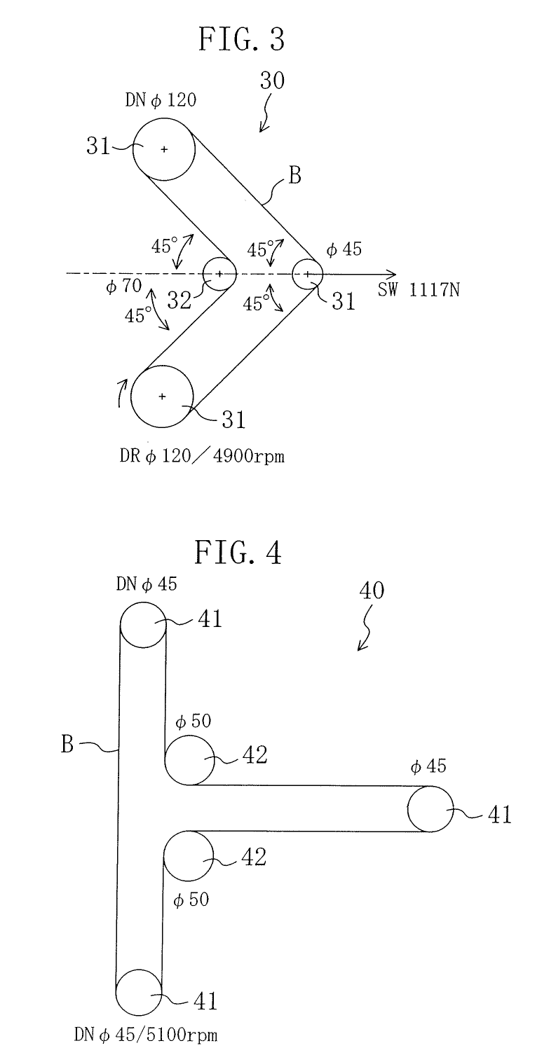

FIG. 3 shows the pulley layout of a deterioration accelerating belt running tester 30 used in order to accelerate the deterioration of each V-ribbed belt.

The deterioration accelerating belt running tester 30 is composed of large-diameter V-ribbed pulleys 31 disposed at upper and lower positions and having a diameter of 120 mm (upper one is a driven pulley and lower one is a drive pulley), an idler pulley 32 disposed vertically midway between the large-diameter V-ribbed pulleys 31 and having a diameter of 70 mm, and a small-diameter V-ribbed pulley 31 disposed to the right of the idler pulley 32 and having a diameter of 45 mm. The idler pulley 32 and the small-diameter V-ribbed pulley 31 are placed to have a total arc of contact of 90° with the belt.

First, each V-ribbed belt B of Examples 1 to 8 (having six V-ribs and a peripheral length of 1210 mm, i.e., 6PK1210) was wrapped around the three V-ribbed pulleys 31 to bring its V-ribs into contact with the pulleys 31, and wrapped around the idler pulley 32 to bring its back face into contact with the pulley 32. In addition, the small-diameter V-ribbed pulley 31 was pulled to the right with a set weight of 1117 N and a load of 8.826 kW was imposed on the large-diameter pulleys 31. In this state, the lower V-ribbed pulley 31 serving as a drive pulley was rotated at 4900 rpm at an ambient temperature of 85±5° C. to move the V-ribbed Belt B for 100 hours.

Next, each V-ribbed belt B after running was assembled to an accessory drive belt drive system in an in-line three-cylinder engine having the same layout as shown in FIG. 2 to apply a specified tension to it, a load was imposed to the alternator pulley 21 to produce a current of 60 A and a compressor having a capacity of 1.47 MPa at 2000 rpm was connected to the air-conditioner pulley 23. In this state, the engine was operated at wide open throttle (WOT) (at a crankshaft speed of 800 rpm) and sound characteristics during operation were subjectively evaluated in six levels: none (0), faint (1), small (2), middle (3), large (4) and excessive (5). The evaluation was made in the case where the tension applied to the V-ribbed belt B was 60N per V-rib, the case where the tension was 45N per V-rib and the case where the tension was 30N per V-rib.

<Bench Test>

FIG. 4 shows the pulley layout of a multi-axis bending belt running tester 40 used in order to evaluate the flexural fatigue strength of each V-ribbed belt.

The multi-axis bending belt running tester 40 is composed of V-ribbed pulleys 41 disposed at upper and lower positions and having a diameter of 45 mm (upper one is a driven pulley and lower one is a drive pulley), idler pulleys 42 disposed one above the other to the right of a vertical midpoint between the V-ribbed pulleys 41 and having a diameter of 50 mm, and a V-ribbed pulley 41 disposed away to the right of the vertical midpoint and having a diameter of 45 mm.

Each V-ribbed belt B of Examples 1 to 8 (having three V-ribs and a peripheral length of 1210 mm, i.e., 3PK1210) was wrapped around the three V-ribbed pulleys 41 to bring its V-ribs into contact with the pulleys 41, and wrapped around the two idler pulleys 42 to bring its back face into contact with the pulleys 42. In addition, the uppermost V-ribbed pulley 41 was pulled up with a dead weight of 588.4 N. In this state, the lowermost V-ribbed pulley 41 serving as a drive pulley was rotated at 5100 rpm to move the V-ribbed Belt B until a crack was produced in any V-rib, and the running time of the belt until the production of a crack was measured.

(Test Evaluation Results)

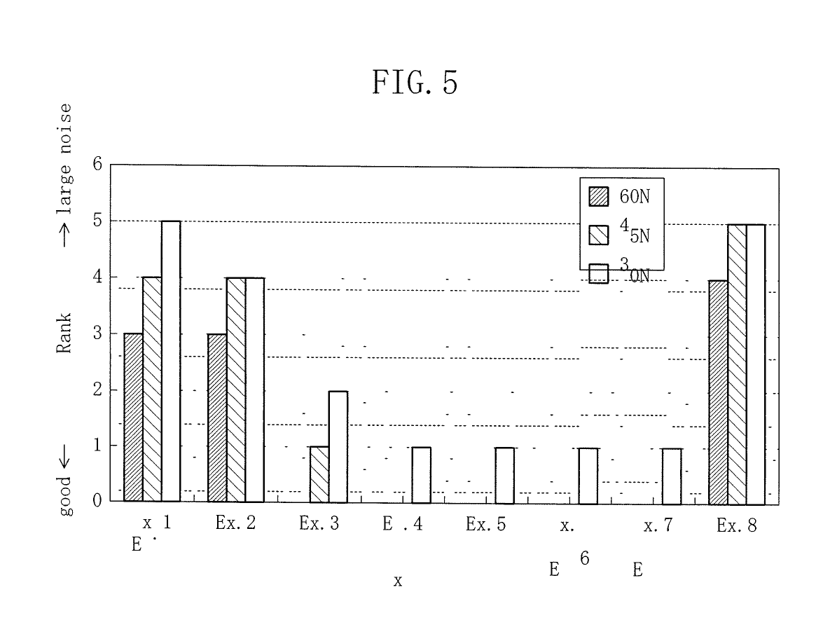

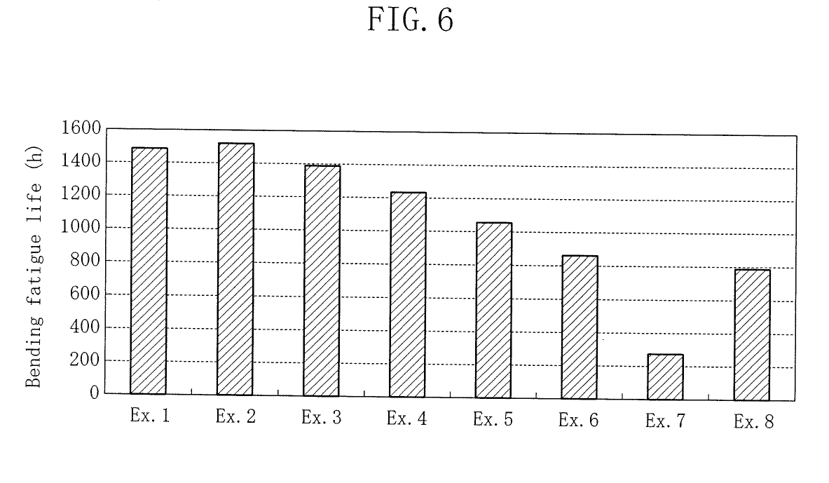

The test results are shown in Table 1 and FIGS. 5 and 6.

TABLE 1

| | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| EPDM | | | 100 | 100 | 100 | 100 | 100 | 100 | 100 | |
| CR | | | | | | | | | | 100 |
| carbon black | | | 50 | 50 | 50 | 50 | 50 | 50 | 50 | 50 |
| softener | | | 14 | 14 | 14 | 14 | 14 | 14 | 14 | |
| plasticizer | | | | | | | | | | 5 |
| zinc oxide | | | 5 | 5 | 5 | 5 | 5 | 5 | 5 | 5 |
| stearic acid | | | 1 | 1 | 1 | 1 | 1 | 1 | 1 | 1 |
| antioxidant | | | 3 | 3 | 3 | 3 | 3 | 3 | 3 | 3 |
| sulfur | | | 1.5 | 1.5 | 1.5 | 1.5 | 1.5 | 1.5 | 1.5 | |
| vulcanization accelerator | | | 4 | 4 | 4 | 4 | 4 | 4 | 4 | |
| magnesium oxide | | | | | | | | | | 4 |
| nylon short fiber | | | 20 | 20 | 20 | 20 | 20 | 20 | 20 | 20 |
| polyethylene resin powder | | | 0 | 2 | 5 | 10 | 20 | 40 | 60 | 0 |
| | Sound | 60N | 3 | 3 | 0 | 0 | 0 | 0 | 0 | 3 |
| | evaluation | 45N | 4 | 4 | 1 | 0 | 0 | 0 | 0 | 4 |
| | | 30N | 5 | 4 | 2 | 1 | 1 | 1 | 1 | 5 |

| | | | | | | | | |
|---|---|---|---|---|---|---|---|---|
| V-rib life (hours) | 1486 | 1512 | 1387 | 1224 | 1050 | 855 | 268 | 783 |

Sound evaluation
0: none,
1: faint,
2: small,
3: middle,
4: large,
5: excessive

Referring to Table 1 and FIG. 5, it can be seen that, in all the cases where the tension applied to the V-ribbed belt B was 60N per V-rib, where the tension was 45N per V-rib and where the tension was 30N per V-rib, Examples 2 to 7 in which polyethylene resin powder is mixed into the compression rubber layer have a higher effect of preventing noise production than Example 1 in which no polyethylene resin powder is mixed into the compression rubber layer and Example 8 using CR instead of EPDM.

Comparison among Examples 2 to 7 shows that Examples 3 to 7 in which the amount of polyethylene resin powder mixed is 5 to 60 parts by mass with respect to 100 parts by mass of EPDM have a significantly higher effect of preventing noise production than Example 2 in which the amount of polyethylene resin powder mixed is 2 parts by mass with respect to the same reference.

Referring to Table 1 and FIG. 6, it can be seen that Examples 2 to 7 in which polyethylene resin powder is mixed into the compression rubber layer deteriorate their flexural fatigue resistance as the amount of polyethylene resin powder mixed increases. Example 2 in which the amount of polyethylene resin powder mixed is 2 parts by mass with respect to 100 parts by mass of EPDM has an equivalent flexural fatigue resistance to Example 1 in which no polyethylene resin powder is mixed. Example 6 in which the amount of polyethylene resin powder mixed is 40 parts by mass with respect to 100 parts by mass of EPDM has an equivalent flexural fatigue resistance to Example 6 using CR instead of EPDM. Example 7 in which the amount of polyethylene resin powder mixed is 60 parts by mass with respect to 100 parts by mass of EPDM has a significantly lower flexural fatigue resistance than the other examples.

As can be seen from the above, in consideration of the balance between the effect of preventing noise production and the flexural fatigue resistance, the amount of polyethylene resin powder mixed into the compression rubber layer is preferably larger than 2 parts by mass and smaller than 60 parts by mass with respect to 100 parts by mass of EPDM.

### INDUSTRIAL APPLICABILITY

As described so far, the present invention is useful for a V-ribbed belt in which a plurality of V-ribs each formed to extend in the belt lengthwise direction are disposed in juxtaposition in the belt widthwise direction on the inner face of the belt and which is wrapped around a pulley to bring the plurality of V-ribs into contact with the pulley for power transmission and for an automotive accessory drive belt drive system using the same.

1. A V-ribbed belt including a plurality of V-ribs each formed to extend in a lengthwise direction of the belt, the plurality of V-ribs being disposed in juxtaposition in a widthwise direction of the belt on the inner face of the belt, the V-ribbed belt being wrapped around a pulley to bring the plurality of V-ribs into contact with the pulley for power transmission, wherein
the plurality of V-ribs are made of a rubber composition in which 5 to 50 parts by mass of thermoplastic resin having a melting point of 110° C. or higher is mixed with 100 parts by mass of ethylene-α-olefin elastomer rubber which is raw rubber.

2. The V-ribbed belt of claim 1, wherein the thermoplastic resin has a thermal deformation temperature of 80° C. or lower.

3. The V-ribbed belt of claim 2, wherein the thermoplastic resin is polyethylene resin.

4. The V-ribbed belt of claim 3, wherein the polyethylene resin serving as the thermoplastic resin is ultrahigh molecular weight polyethylene resin having a viscosity-average molecular weight of 500000 or more.

5. The V-ribbed belt of claim 1, wherein the thermoplastic resin is in powder or particulate form.

6. The V-ribbed belt of claim 5, wherein the thermoplastic resin in powder or particulate form has a particle diameter of 25 to 300 μm.

7. The V-ribbed belt of claim 1, wherein 3 to 30 parts by mass of short fibers are mixed into the rubber composition forming the plurality of V-ribs with respect to 100 parts by mass of ethylene-α-olefin elastomer rubber which is raw rubber, the short fibers being oriented in the widthwise direction of the belt.

8. The V-ribbed belt of claim 7, wherein the short fibers are nylon short fibers.

9. The V-ribbed belt of claim 1, further comprising a cord made of polyethylene naphthalate fibers and embedded to form a spiral with a certain pitch in the widthwise direction of the belt.

10. An automotive accessory drive belt drive system including: a V-ribbed belt in which a plurality of V-ribs each formed to extend in a lengthwise direction of the belt are disposed in juxtaposition in a widthwise direction of the belt on the inner face of the belt; and a plurality of pulleys around which the V-ribbed belt is wrapped in a tension-fixed manner, wherein
the plurality of V-ribs of the V-ribbed belt are made of a rubber composition in which 5 to 50 parts by mass of thermoplastic resin having a melting point of 110° C. or higher is mixed with 100 parts by mass of ethylene-α-olefin elastomer rubber which is raw rubber, and
the tension applied to the V-ribbed belt before running is 50 to 80 N per V-rib.
